(19) United States
(12) Patent Application Publication
(10) Pub. No.: US 2026/0156637 A1
(43) Pub. Date: Jun. 4, 2026

(54) SINGLE DCI SCHEDULING FOR MULTIPLE CELL CARRIER SELECTION

(71) Applicant: Telefonaktiebolaget LM Ericsson (PUBL), Stockholm (SE)

(72) Inventors: Ajit NIMBALKER, Santa Clara, CA (US); Ravikiran NORY, Santa Clara, CA (US)

(21) Appl. No.: 19/126,310

(22) PCT Filed: Nov. 7, 2023
(86) PCT No.: PCT/EP2023/081057

§ 371 Date: May 1, 2025

Related U.S. Application Data
(60) Provisional application No. 63/423,140, filed on Nov. 7, 2022.

(51) Int. Cl. H04W 72/12; H04W 72/231; H04W 72/51; H04W 76/20

(52) U.S. Cl. CPC H04W 72/12; H04W 72/231; H04W 72/51; H04W 76/20

(57) ABSTRACT

Embodiments disclosed herein comprise methods performed by a wireless device or UE, methods performed by a base station, wireless device apparatus and base station apparatus configured for carrier aggregation with cross carrier scheduling. In some embodiments a method performed by a wireless device (1200) for carrier aggregation with cross carrier scheduling comprises receiving (500) a configuration for a first group of cells to be scheduled. The method furthermore comprises receiving (530) on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

### TECHNICAL FIELD

Embodiments herein relate generally to a base station and a method in the base station, and to a wireless device and a method in the wireless device. More particularly the embodiments herein relate to radio communications, and in particular, to scheduling for multiple cells using a single downlink control information.

### BACKGROUND

Carrier Aggregation is generally used in NR (5G) and LTE systems to improve a 3GPP wireless device, also referred to as a user equipment (UE) transmit and/or receive data rate. With carrier aggregation (CA), the UE typically operates initially on single serving cell called a primary cell Pcell. The Pcell is operated on a component carrier in a frequency band. The UE is then configured by the network with one or more secondary serving cells (Scell(s)). Each Scell can correspond to a component carrier (CC) in the same frequency band (intra-band CA) or different frequency band (inter-band CA) from the frequency band of the CC corresponding to the Pcell. For the UE to transmit/receive data on the Scell(s) (e.g by receiving downlink scheduling DL-SCH information on a physical downlink shared channel (PDSCH) or by transmitting UL-SCH on a physical uplink shared channel (PUSCH), the Scell(s) need to be activated by the network. The Scell(s) can also be deactivated and later reactivated as needed via activation/deactivation signaling.

For NR carrier aggregation, cross-carrier scheduling (CCS) has been specified, for example in 3^{rd} Generation Partnership Project (3GPP) technical specification (TS) 38.213 V17.3.0, using following framework:
1. UE has a primary serving cell and can be configured with one or more secondary serving cells (SCells)
2. For a given SCell with Scell index X,
a) if the SCell is configured with a ‘scheduling cell’ with cell index Y (cross-carrier scheduling)
   i) SCell X is referred to as the ‘scheduled cell’
   ii) UE monitors DL physical downlink control channel (PDCCH) on the scheduling cell Y for assignments/grants scheduling PDSCH/PUSCH corresponding to Sell X.
   iii) PDSCH/PUSCH corresponding to Sell X cannot be scheduled for the UE using a serving cell other than scheduling cell Y
b) Otherwise
   i) SCell X is the scheduling cell for SCell X (same-carrier scheduling)
   ii) UE monitors DL PDCCH on SCell X for assignments/grants scheduling PDSCH/PUSCH corresponding to Sell X
   iii) PDSCH/PUSCH corresponding to Sell X cannot be scheduled for the UE using a serving cell other than SCell X
3. An SCell cannot be configured as a scheduling cell for the primary cell. The primary cell is always its own scheduling cell.

Dual Connectivity (DC) is generally used in NR (5G) and LTE systems to improve UE transmit receive data rate. With DC, the UE typically operates a master cell group (MCG) and a secondary cell group (SCG). Each cell group can have one or more serving cells. The MCG cell, operating on the primary frequency, in which the UE either performs the initial connection establishment procedure or initiates the connection re-establishment procedure is referred to as the primary cell or PCell. The SCG cell in which the UE performs random access when performing the Reconfiguration with Sync procedure is referred to as the primary SCG cell or PSCell.

In some cases, the term “primary cell” or “primary serving cell” can refer to PCell for a UE not configured with DC.

In 3GPP NR standard, downlink control information (DCI) is received over the physical layer downlink control channel (PDCCH). The PDCCH may carry DCI in messages with different formats. DCI format 0_0 and 0_1 are DCI messages used to convey uplink grants to the UE for transmission of the physical layer data channel in the uplink (PUSCH) and DCI format 1_0 and 1_1 are used to convey downlink grants for transmission of the physical layer data channel in the downlink (PDSCH). Other DCI formats (20, 2_1, 2_2 and 2_3) are used for other purposes such as transmission of slot format information, reserved resource, transmit power control information etc. See, for example, 3GPP TS 38.212 V17.3.0.

A PDCCH candidate is searched within a common or UE-specific search space which is mapped to a set of time and frequency resources referred to as a control resource set (CORESET). The search spaces within which PDCCH candidates must be monitored are configured to the UE via radio resource control (RRC) signaling. A monitoring periodicity is also configured for different PDCCH candidates. In any particular slot the UE may be configured to monitor multiple PDCCH candidates in multiple search spaces which may be mapped to one or more CORESETs. PDCCH candidates may need to be monitored multiple times in a slot, once every slot or once in multiple of slots.

The smallest unit used for defining CORESETs is a Resource Element Group (REG) which is defined as spanning 1 PRB x 1 OFDM symbol in frequency and time. Each REG contains demodulation reference signals (DM-RS) to aid in the estimation of the radio channel over which that REG was transmitted. When transmitting the PDCCH, a precoder could be used to apply weights at the transmit antennas based on some knowledge of the radio channel prior to transmission. It is possible to improve channel estimation performance at the UE by estimating the channel over multiple REGs that are proximate in time and frequency if the precoder used at the transmitter for the REGs is not different. To assist the UE with channel estimation the multiple REGs can be grouped together to form a REG bundle and the REG bundle size for a CORESET is indicated to the UE. The UE may assume that any precoder used for the transmission of the PDCCH is the same for all the REGs in the REG bundle. A REG bundle may consist of 2, 3 or 6 REGs.

A control channel element (CCE) consists of 6 REGs. The REGs within a CCE may either be contiguous or distributed in frequency. When the REGs are distributed in frequency, the CORESET is said to be using an interleaved mapping of REGs to a CCE and if the REGs are not distributed in frequency, a non-interleaved mapping is said to be used.

A PDCCH candidate may span 1, 2, 4, 8 or 16 CCEs. The number of aggregated CCEs used is referred to as the aggregation level for the PDCCH candidate. A hashing function is used to determine the CCEs corresponding to PDCCH candidates that a UE must monitor within a search space set. The hashing can be done differently for different UEs so that the CCEs used by the UEs are randomized and the probability of collisions between multiple UEs for which PDCCH messages are included in a CORESET is reduced.

For a search space set s associated with CORESET p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI} are given by

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where
for any common search space CSS,

$${Y}_{p , {n}_{s , f}^{μ}} = 0 ;$$

for a UE specific search space USS,

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI} ≠0, A_{P}=39827 for pmod3=0, A_{P}=39829 for pmod3=1, A_{P}=39839 for pmod3=2, and D=65537;

$$i = 0 , … , L - 1 ;$$

N_{CCE,p} is the number of CCEs, numbered from 0 to N_{CCE,p}−1, in CORESET p and, if any, per RB set;
n_{CI} is the carrier indicator field value if the UE is configured with a carrier indicator field by CrossCarrierSchedulingConfig for the serving cell on which PDCCH is monitored; otherwise, including for any CSS, n_{CI}=0;

$${m}_{s , {n}_{CI}}^{( L )} = 0 , … , {M}_{s , {n}_{CI}}^{( L )} - 1 ,$$

where

$${M}_{s , {n}_{CI}}^{( L )}$$

is the number of PDCCH candidates the UE is configured to monitor for aggregation level L of a search space set s for a serving cell corresponding to n_{CI};
for any common search space CSS

$${M}_{s , max}^{( L )} = {M}_{s , 0}^{( L )} ;$$

for a UE specific search space USS,

$${M}_{s , max}^{( L )}$$

is the maximum of

$${M}_{s , {n}_{CI}}^{( L )}$$

over all configured n_{CI} values for a CCE aggregation level L of search space set s;
   the RNTI value used for n_{RNTI} is the C-RNTI.

Blind decoding of potential PDCCH transmissions is attempted by the UE in each of the configured PDCCH candidates within a slot. The complexity incurred at the UE to do this depends on number of blind decoding attempts and the number of CCEs which need to be processed.

### SUMMARY

Some examples involve a method to enable carrier grouping and using a DCI for scheduling multiple cells to indicate the set of cells scheduled by the DCI.

The following advantages may be accounted to one or more embodiments disclosed herein. Carrier grouping/sets and use of a single the DCI allows efficient scheduling of multiple cells. The ability to support DCI formats that are used for scheduling two different sets of cells from a same scheduling cell can improve scheduling flexibility and reduce UE complexity.

In a first aspect, a method is performed by a wireless device for carrier aggregation with cross carrier scheduling. The method comprising receiving a configuration for a first group of cells to be scheduled. The method further comprising receiving on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

In a second aspect, a method performed by a base station for scheduling a wireless device for carrier aggregation with cross carrier scheduling is provided. The method comprising transmitting a configuration for a first group of cells to be scheduled. The method further comprising transmitting on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

In a third aspect a wireless device is provided. In some examples the wireless device comprises power supply circuitry configured to supply power to the wireless device, memory circuitry and processing circuitry, the processing circuitry configured to receive a configuration for a first group of cells to be scheduled; and receive on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

In a fourth aspect a base station is provided. In some examples the base station comprises power supply circuitry configured to supply power to the base station, memory circuitry and processing circuitry, the processing circuitry configured to transmit a configuration for a first group of cells to be scheduled; and transmit on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

In a fifth aspect a computer program, program product or carrier comprising a a computer program is provided. The computer program comprising instructions which when executed on a computer processor cause the computer to perform any of the methods described herein.

### FIGURES

FIG. 1 is a block diagram depicting an example according to one or more embodiments disclosed herein.

FIG. 2 is a block diagram depicting an example according to one or more embodiments disclosed herein.

FIG. 3 is a block diagram depicting an example according to one or more embodiments disclosed herein.

FIG. 4 is a block diagram depicting an example according to one or more embodiments disclosed herein.

FIG. 5 is a flow diagram depicting an example according to one or more embodiments disclosed herein.

FIG. 6 is a flow diagram depicting an example according to one or more embodiments disclosed herein.

FIG. 7 depicts scheduling eight cells using two sets of four cells each from one scheduling cell FIG. 8 depicts legacy CCS limits in case 1A (in LHS), and limits for me-DCI based CCS in Case 1B (in RHS).

FIG. 9 depicts configuration of BDs for the different DCI formats. (16 BDs is for legacy DCI CCS from pcell to scell1).

FIG. 10 is an illustration showing linked search space where cell 1 is used to schedule DCI 0_X/1_X for two groups (cells 2 and 3, and cells 4 and 5 respectively).

FIG. 11 shows an example of a communication system 1100 in accordance with some embodiments.

FIG. 12 shows a UE 1200 in accordance with some embodiments.

FIG. 13 shows a network node 1300 in accordance with some embodiments.

FIG. 14 is a block diagram of a host 1400, which may be an embodiment of the host 1116 of FIG. 11, in accordance with various aspects described herein.

FIG. 15 is a block diagram illustrating a virtualization environment 1500 in which functions implemented by some embodiments may be virtualized.

FIG. 16 shows a communication diagram of a host 1602 communicating via a network node 1604 with a UE 1606 over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the Appendix.

In current CA framework with cross-carrier scheduling, a single DCI can schedule PUSCH/PDSCH on one cell.

There is a need for efficiently supporting multi carrier DCI design when a variable number of cells (e.g. up to 4 cells) are scheduled using a single DCI from one scheduling cell. There is also a need for efficiently supporting multi carrier DCI design when many cells (e.g. up to 15 cells) are scheduled from one scheduling cell using one or more DCIs, each scheduling multiple cells.

If a UE is configured with a first number of cells to be scheduled via a single DCI scheduling multiple cells, an explicit bitmap indicating carrier selection with one bit per each one of the first number of cells is included in a single DCI configured to schedule the first number of cells.

In some examples when a UE is configured with a second number of cells to be scheduled via a single DCI scheduling multiple cells, using an explicit field indicating carrier selection, wherein each codepoint of the field indicates a set of one or more of the second number of cells, wherein the cells belonging to each set is explicitly indicated via a higher layer configuration.

In some examples for UE configured to monitor a first DCI format (DCI x) that can schedule PDSCH/PUSCH resource assignments/grants for a first set of (configured) serving cells and a second DCI format (DCI y) that can schedule PDSCH/PUSCH resource assignments/grants for a second set of (configured) serving cells and the first and second DCI formats are monitored on a same scheduling cell, methods to distinguish between the two DCI formats are disclosed.

Some examples involve a method to enable carrier grouping and using a carrier selection field in DCI scheduling multiple cells (DCI x) to indicate the set of cells scheduled by the DCI, wherein the format of the carrier selection field (bitmap with one bit per cell, or an RRC configured table, wherein each row of the table indicates a set of cells).

Some examples involve a method to distinguish DCI formats that are used for scheduling two different sets of cells using a same scheduling cell by inclusion of an explicit set index in the DCI formats or other such means as described in more detail herein.

The following advantages may be accounted to one or more embodiments disclosed herein. Carrier grouping/sets and use of carrier selector field in the DCI allows efficient scheduling of multiple cells. The ability to support DCI formats that are used for scheduling two different sets of cells from a same scheduling cell can improve scheduling flexibility and reduce UE complexity.

### Carrier Selection

In one embodiment, the UE is configured to monitor a DCI format (mc-DCI) that can schedule PDSCH/PUSCH resource assignments/grants for a first set of (scheduled) serving cells that are a subset of a second set of (configured) serving cells. The UE determines the first set of serving cells using a bitfield (carrier selector field) in the DCI format using the following procedure. If an RRC configuration is present, the bitfield is used in conjunction with the RRC configuration to determine the first set of serving cells from the second set of serving cells. Otherwise, the bitfield used a bitmap to determine the first set of serving cells from the second set of serving cells

In one example, the RRC configuration provides a mapping table that maps each code point corresponding to the bits of the bitfield to one or more cells from the second set of cells.

In one example, the RRC configuration is provided only if the number of cells in the second set of cells is larger than the number of bits of the bitfield. When the bitfield is used as a bitmap, each bit position in the bitmap corresponds to one serving cell of the second set of cells. For example, LSB to MSB are mapped to cells with smallest to largest cellid of the second set of cells.

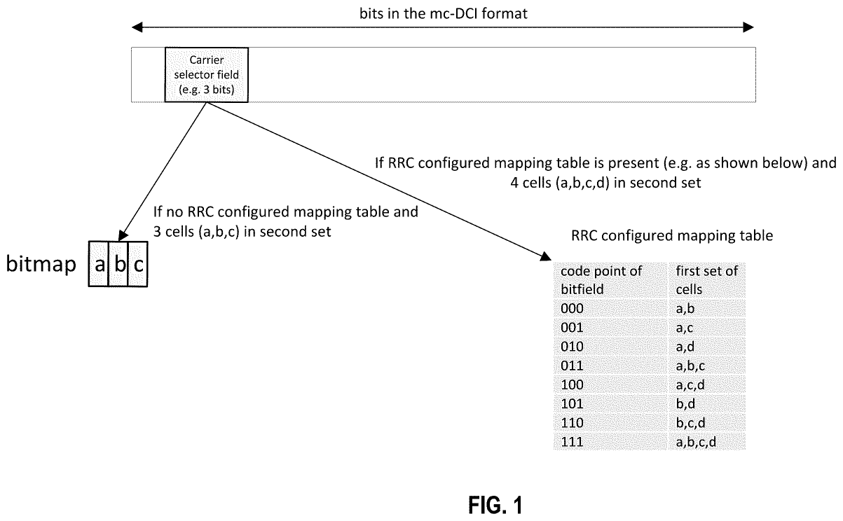

FIG. 1 shows an example. In the example, the carrier selector field is assumed to be 3 bits long. As shown in the figure, if RRC configured table is present then the bitfield is interpreted using that table. If not present, then bitfield is simply interpreted as a bitmap. This avoids the unnecessary overhead of configuring the table for cases where bitmap can be used, i.e., when number of cells in the second set of cells is same as the number of bits of the bitfield.

The number of bits of the bitfield is generally expected to be small value e.g. 1, 2 or 3 bits to keep the DCI overhead low. The number of cells in the second set of cells in some cases can be larger than the number of bits of the bitfield (e.g., 4 or 8 cells) for which RRC configured table is provided, and in cases where it is not large e.g., 2 or 3 cells, the RRC configured table is not provided and instead the bits are interpreted as a bitmap.

Multiple Set of Cells Scheduled Using Multiple DCIs from a Same Scheduling Cell

In an embodiment, a UE is configured to monitor a first DCI format (mc-DCI) that can schedule PDSCH/PUSCH resource assignments/grants for a first set of (configured) serving cells and a second DCI format (mc-DCI) that can schedule PDSCH/PUSCH resource assignments/grants for a second set of (configured) serving cells, wherein the first and second DCI formats are monitored on a same scheduling cell.

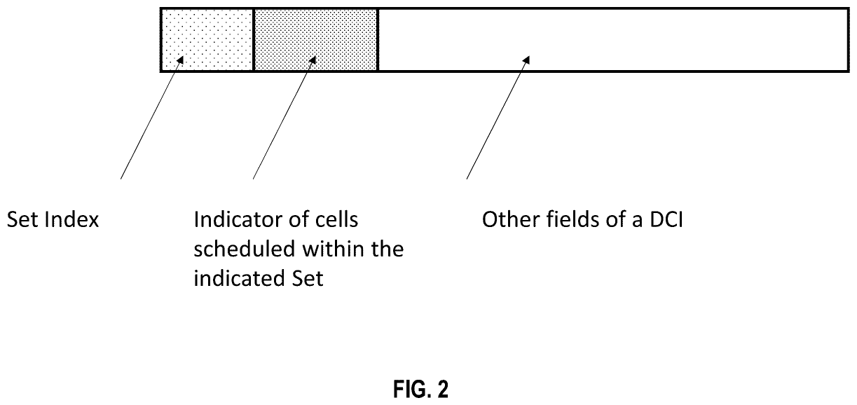

FIG. 2 depicts an example DCI fields. At least one of the first DCI format and the second DCI format includes a first field for indicating set index, wherein the set index indicates an index associated with the first set of (configured) serving cells or with the second set of (configured) serving cells.

In an embodiment, at least one of the first DCI format and the second DCI format further includes a second field for indicating the set of scheduled cells from the indicated set of (configured) serving cells determined from the first field.

In an embodiment, the first field indicating a set index is included in a DCI format on a scheduling cell when the number of sets of (configured) serving cells that can be scheduled using a DCI format (mc-DCI) that can schedule PDSCH/PUSCH resource assignments/grants is larger than one.

In an embodiment the first field indicating a set index is included in a DCI format scheduling single cell [example DCI 1-1], when the DCI format is monitored on a scheduling cell that is also configured for transmission of a DCI format that can schedule PDSCH/PUSCH resource assignments/grants on multiple cells.

In an embodiment, the CRC of the first DCI format is scrambled with a first RNTI, and the CRC of the second DCI format is scrambled with a second RNTI. The first and second RNTI may be configured by higher layers. The first and second RNTI may be distinct from each other. At least one of the first DCI format and the second DCI format have distinct DCI payload sizes. The size of at least one of the first DCI format and the second DCI format size are indicated by higher layers. The size can be indicated such that it is distinct between the DCI formats to avoid having an explicit field.

If the size of at least one of the first DCI format payload and the second DCI format payload size are equal, a set index field is included in the first and second DCI formats. indicated by higher layers. The size can be indicated such that it is distinct between the DCI formats to avoid having an explicit field.

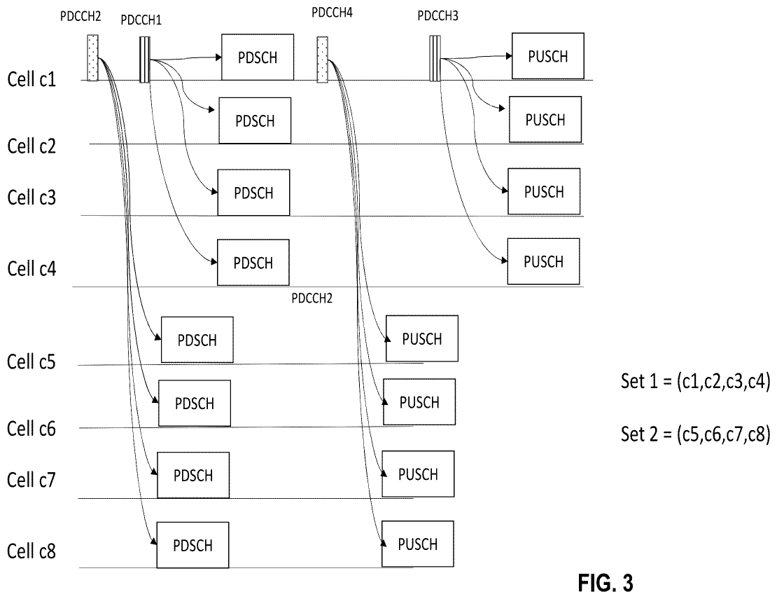

An example is shown in FIG. 3. The figure depicts two sets of cells—first set has c1, c2,c3,c4 and the second set has c5,c6,c7,c8, and each of the two sets are configured to be scheduled by DCI that schedules PDSCH/PUSCH resource assignments/grants on multiple cells. For example, PDCCH1 schedules PDSCH on cells c1-c4 using a first me-DCI, and PDCCH2 schedules PDSCH on cells c5-c8 using a second me-DCI. The two PDCCHs may be detected in the same slot on the scheduling cell c1. Similarly, PDCCH3 schedules PDSCH on cells c1-c4 using a third mc-DCI, and PDCCH4 schedules PDSCH on cells c5-c8 using a fourth me-DCI. The two PDCCHs may be detected in the same slot on the scheduling cell c1.

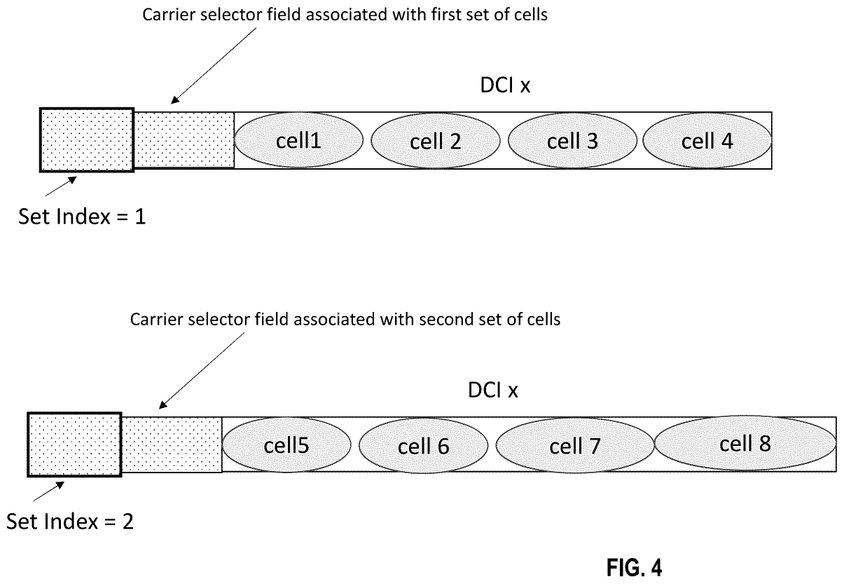

An example of the first and second DCI formats is illustrated in the FIG. 4. The top figure shows a DCI format X with a first field ‘set index’ set to 1 and a carrier selector field associated with first set of cells and fields for each of the four cells 1, 2, 3, 4. The lower figure shows a DC format X with the first field ‘set index’ set to two and a carrier selector field associated with the second set of cells and fields for each of the four cells 5, 6, 7, 8. Note that the sets can be also indexed 0.1 instead of one and two.

In certain embodiments, the search space for monitoring a DCI X is based on at least the set index associated with the first set of cells or the second set of cells. Furthermore, in certain embodiments the search space may be based on the carrier selector field associated with the set.

In certain embodiments the number of sets that UE can support is indicated via UE capability signalling.

In certain embodiments the DCI for scheduling the second set of cells may be transmitted in the search space associated with the first set of cells and vice versa.

### Additional Aspects for Supporting Single DCI Scheduling Multiple Cells

One more issue may arise regarding handling of blind detections (BD)s of DCI 0_X/1_X in the overbooking procedure when the primary cell belongs to a set of cells and is the scheduling cell for the set. PDCCH processing capabilities of the UE are limited depending on the SCS, primarily to enable low processing latencies, with up to, e.g., 44 blind decodes and 56 CCEs for channel estimation per slot in the case of 15 kHz SCS. However, on a primary cell where all types of CSSs are monitored, gNB may configure a number of BDs/CCEs per slot that exceeds the UE processing limits, which is further referred to as overbooking. Based on configuration and for each slot, UE and gNB map PDCCH candidates according to the same mapping rules, where CSS is mapped before USS, USSs are mapped with increasing SS-set index, and for the USS part entire SS-set(s) may not be mapped (i.e. dropped) in a given slot if the UE processing limits would be exceeded.

In some embodiments for overbooking, the USS for 0_X/1_X can be treated as one of below options. While either option works, it seems straight-forward to allow dropping.
Option 1: Allow dropping (e.g. like a PCell USS set)
Option 2: No dropping (e.g. like a SCell USS set)

For a set of cells which is configured for multi-cell scheduling, if the primary cell belongs to the set and is a scheduling cell for the set, USS sets corresponding to DCI 0_X/1_X for the set can be dropped in search space overbooking procedure.

Following RRC configuration aspect may also be needed.

Configuration of one or more set(s) of cells for DCI 0_X/1_X, respectively, and the scheduling cell
Separate configuration for uplink and downlink DCI formats
Configuration of search space for DCI 0_X/1_X on scheduling cell and a scheduled cell for each set, including separate search space for DCI 0_X and DCI 1_X
Configuration of n_CI for each set of cells for use in the search space hashing function
Configuration of DCI size for DCI 0_X/1_X for each set
Configuration of DCI fields for DCI 0_X/1_X
Configuration of subgroups among the set of cells, including maximum number of subgroups (up to 4)
Details of joint TDRA configuration among the set of cells
   configuration of TDRA table used for PUSCH/PDSCH scheduling (per-cell per set of cells)
Details of FDRA configuration
   configuration of RBG size(s) used for PUSCH/PDSCH scheduling (per-cell per set of cells)
Details of MCS configuration
   configuration of up to eight differential MCS offsets used for PUSCH/PDSCH scheduling (per-cell per subgroup)
RV field size is explicitly configurable per cell (0/1/2 bits)

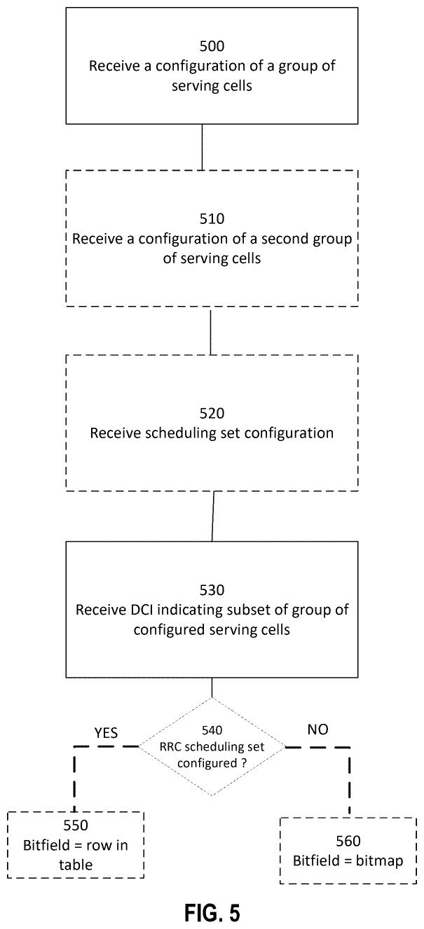

In FIG. 5 an example method performed by a wireless device is depicted. The wireless device may also be termed a user equipment, UE. The wireless device may be suitably arranged for carrier aggregation with cross carrier scheduling, The method starts at step 500 with the wireless device receiving a configuration for a first group of cells (e.g. serving cells) to be scheduled. The method proceeds at step 530 with the wireless device receiving on a scheduling cell a downlink control information, DCI, indicating two or more cells to be scheduled from the first group of cells. In some examples the wireless device receives at step 520 a configuration for a plurality of groups of cells and wherein the downlink control information comprises an indication to one of the configured groups of cells. In some examples the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

In some examples the configuration corresponds to a table and the indication in the downlink control information corresponds to a row of the table. For example, the configuration may comprise a radio resource control, RRC, message to provide an RRC scheduling set configuration comprising parameters corresponding to the entries of the table. In some examples the table may be defined in a standard specification such as 3GPP.

The table may be fully specified or require part configuration via RRC parameters. In some examples the indicated two or more cells are a subset of the configured first group of cells. The method may further comprise the step of determining 540 how the bitfield is to be interpreted. In some examples the use of the bitfield in the downlink control information is determined according to one of the following: when an RRC scheduling set configuration is present, the bitfield is used in conjunction with the RRC configuration to determine the two or more cells from the first group of cells, e.g. as a row in a table step 550. Alternatively when no RRC scheduling set configuration is present the bitfield is used as a bitmap to determine the two or more cells from the first group of cells, step 560. In some examples the RRC scheduling set configuration is only provided when the number of cells to be scheduled exceeds a fixed length of the bitfield of the downlink control information. In some examples when the bitfield is used as a bitmap, each bit position in the bitmap corresponds to one serving cell of the two or more cells. For example the least significant bit LSB to the most significant bit MSB are mapped to cells from the smallest to largest cellid. In other examples the MSB to the LSB are mapped to the cells from the smallest to the largest cellid.

The method may include the step 510 of receiving a configuration for a second group of cells (e.g. serving cells) to be scheduled, wherein the second group of cells may be different from the first group and may comprise different cells from the first group. In this example receiving on the scheduling cell the downlink control information, DCI, comprises receiving an indication of two or more cells to be scheduled from one of the first group of cells and the second group of cells. In some examples the DCI comprises a carrier selection field for indicating one of the first group of cells and the second group of cells and a bitmap wherein one bit corresponds to a cell of the two or more cells to be scheduled. As indicated previously, the DCI for the first group of cells may have a first format. In some examples, the downlink control information for the second group of cells may have a second format, different from the first. The method may further comprise detecting one of the first format and the second format in the same search space of the scheduling cell. In some examples at least one of the first format and the second format comprises a first field for indicating a set or group index, wherein the set index indicates an index associated with the first group of configured cells or with the second group of configured cells. In some examples at least one of the first format (e.g. DCI format) and the second format (e.g. DCI format) further comprises a second field for indicating the set of scheduled cells from the set of configured serving cells determined from the first field. In some examples the first field indicating a set index is included in the downlink control information format on a scheduling cell only when the number of groups of configured cells that can be scheduled is greater than one. In some examples first field indicating a set index is included in a format scheduling single cell when the downlink control information format is monitored on a scheduling cell that is also configured for transmission of a downlink control information format that schedules PDSCH/PUSCH resource assignments/grants on multiple cells. In some examples the method comprises a cyclic redundancy check, CRC, sequence of the first DCI format is scrambled with a first radio network temporary identifier, RNTI, and the CRC sequence of the second DCI format is scrambled with a second RNTI. In some examples the first and second RNTI are configured by higher layers. In some examples the first and second RNTI are distinct from each other. In further examples at least one of the first DCI format and the second DCI format have distinct DCI payload sizes. In some examples a size of at least one of the first format and the second format are indicated by higher layers. In some examples a size is indicated such that it is distinct between the formats to avoid having an explicit field. In some examples when a size of at least one of the first format payload and the second format payload size are equal, a set index field is included in the first and second DCI formats.

In some examples the search space for monitoring the downlink control information is based on at least the set index associated with the first set of cells or the second set of cells. The search space may be based on the carrier selector field associated with the set. In some examples the downlink control information for scheduling the second group of cells is transmitted in the search space associated with the first group of cells. In some examples the number of sets that UE can support is indicated via a UE capability signalling message. In some examples the group of cells which is configured for multi-cell scheduling comprises a primary cell which is the scheduling cell for the set. UE specific search space, USS, sets corresponding to a scheduling downlink control information for the set (e.g. DCI 0_X/1_X) may be dropped in a search space overbooking procedure. In some examples one or more additional configurations may be required. For example, RRC configuration of one or more set(s) of cells for DCI 0_X/1_X, respectively, and the scheduling cell. This may include separate configuration for uplink and downlink DCI formats. Configuration of search space for DCI 0_X/1_X on scheduling cell and a scheduled cell for each set, including separate search space for DCI 0_X and DCI 1_X. Configuration of a n_CI for each set of cells for use in the search space hashing function, where the n_CI is a variable that is used in search space hashing function. Configuration of DCI size for DCI 0_X/1_X for each set. Configuration of DCI fields for DCI 0_X/1_X comprising one or more of a configuration of subgroups among the group of cells, including maximum number of subgroups (up to 4); details of a joint time domain resource allocation, TDRA, configuration among the group of cells and/or comprising configuration of TDRA table used for PUSCH/PDSCH scheduling (per-cell per set of cells); details of a frequency domain resource allocation, FDRA, configuration and/or configuration of RBG size(s) used for PUSCH/PDSCH scheduling per-cell per set of cells; details of MCS configuration and/or comprising configuration of up to eight differential MCS offsets used for PUSCH/PDSCH scheduling per-cell per subgroup; and redundancy version, RV, field size is explicitly configurable per cell.

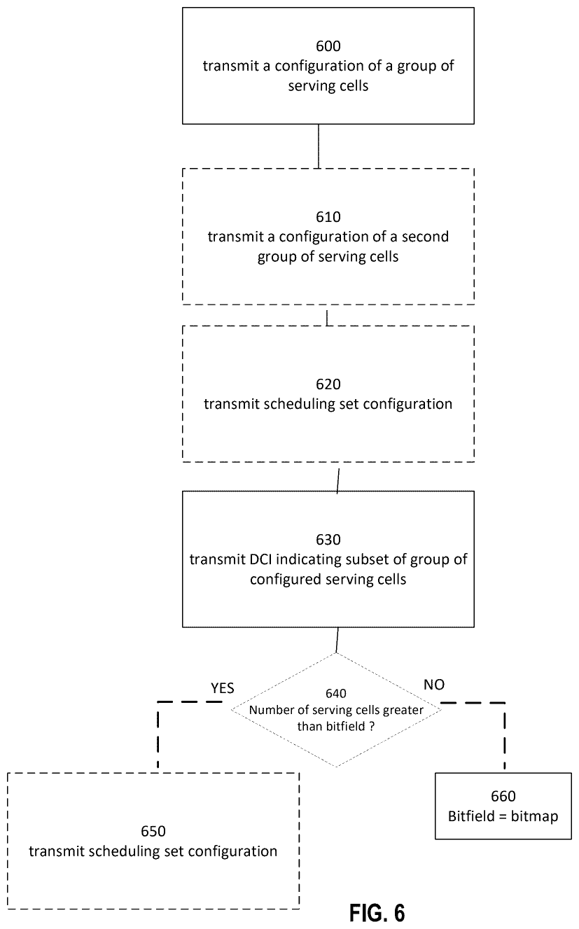

In FIG. 6 a method performed by a network node or radio base station is depicted. The base station is suitably adapted for scheduling a wireless device for carrier aggregation with cross carrier scheduling. The method begins with step 600 with the base station transmitting a configuration for a first group of cells to be scheduled, e.g. a group of serving cells. The method proceeds with step 630 transmitting on a scheduling cell a downlink control information indicating two or more cells to be scheduled from the first group of cells. In some examples the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

In some examples the base station transmits a configuration for a plurality of groups of cells and wherein the downlink control information comprises an indication to one of the configured groups of cells. In some examples the configuration corresponds to a table and the indication in the downlink control information corresponds to a row of the table. In some examples the base station transmits a configuration comprising a radio resource control, RRC, message to provide an RRC scheduling set configuration 620. In some examples the configuring comprises parameters corresponding to the entries of a table. In some examples the indicated two or more cells are a subset of the configured first group of cells. In some examples the base station determined 640 when to transmit the RRC scheduling set configuration 650. The RRC scheduling set configuration may only be provided when the number of cells to be scheduled exceeds a fixed length of the bitfield of the downlink control information. In some examples, when an RRC scheduling set configuration is transmitted, the bitfield is used in conjunction with the RRC configuration to determine the two or more cells from the first group of cells; and when no RRC scheduling set configuration is present the bitfield is configured as a bitmap 660 to explicitly identify the two or more cells from the first group of cells. In some examples when the bitfield is used as a bitmap, each bit position in the bitmap corresponds to one serving cell of the two or more cells. In some examples, the least significant bit to the most significant bit are mapped to cells from the smallest to largest cellid. The method may further comprise the base station transmitting 610 a configuration for a second group of cells to be scheduled, wherein the second group of cells is different from the first group and comprises different cells from the first group. In this example the transmitting on the scheduling cell of the downlink control information indicates two or more cells to be scheduled from one of the first group of cells and the second group of cells. In some examples the downlink control information comprises a carrier selection field for indicating one of the first group of cells and the second group of cells and a bitmap wherein one bit corresponds to a cell of the two or more cells to be scheduled. As described previously, in some examples, the downlink control information for the first group of cells has a first format. In some examplesthe downlink control information for the second group of cells has a second format, different from the first. The method may further comprise transmitting one of the first format and the second format in the same search space of the scheduling cell. In some examples at least one of the first format and the second format comprises a first field for indicating a set index, wherein the set index indicates an index associated with the first group of configured cells or with the second group of configured cells. In some examples at least one of the first format and the second format further comprises a second field for indicating the set of scheduled cells from the set of configured serving cells determined from the first field. In some examples the first field indicating a set index is included in the downlink control information format on a scheduling cell only when the number of groups of configured cells that can be scheduled is greater than one. In some examples the first field indicating a set index is included in a format scheduling single cell when the downlink control information format is monitored on a scheduling cell that is also configured for transmission of a downlink control information format that schedules PDSCH/PUSCH resource assignments/grants on multiple cells.

In other examples the DCI configuration and other configuration aspects to support the cross carrier scheduling as described herein for the wireless device are applicable to the methods described for a base station

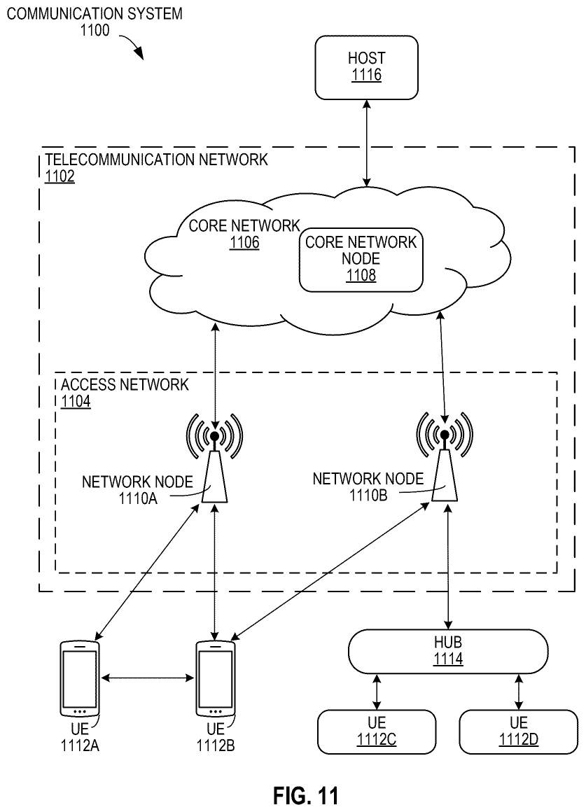

In the example in FIG. 11, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

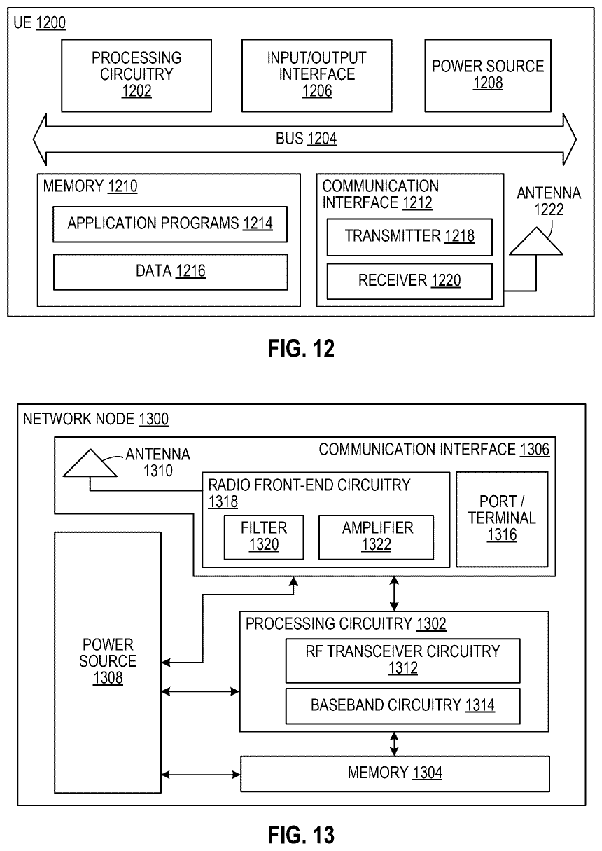

In FIG. 12, as used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In some examples the processing circuitry 1202 is configured to receive a configuration for a first group of cells to be scheduled and receive on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field. In some examples the processing circuitry 1202 is further configured to perform any of the embodiments disclosed herein associated with a wireless device or UE 1200.

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof Δn input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof Δn output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

In FIG. 13 as used herein, network node refers to equipment capable, configured, arranged and/or operable to communicate directly or indirectly with a UE and/or with other network nodes or equipment, in a telecommunication network. Examples of network nodes include, but are not limited to, access points (Aps) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some examples the processing circuitry 1302 is configured to transmit a configuration for a first group of cells to be scheduled and transmit on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field. In some examples the processing circuitry 1302 is further configured to perform any of the embodiments associated with the network node or base station 1300, as described herein.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or uEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

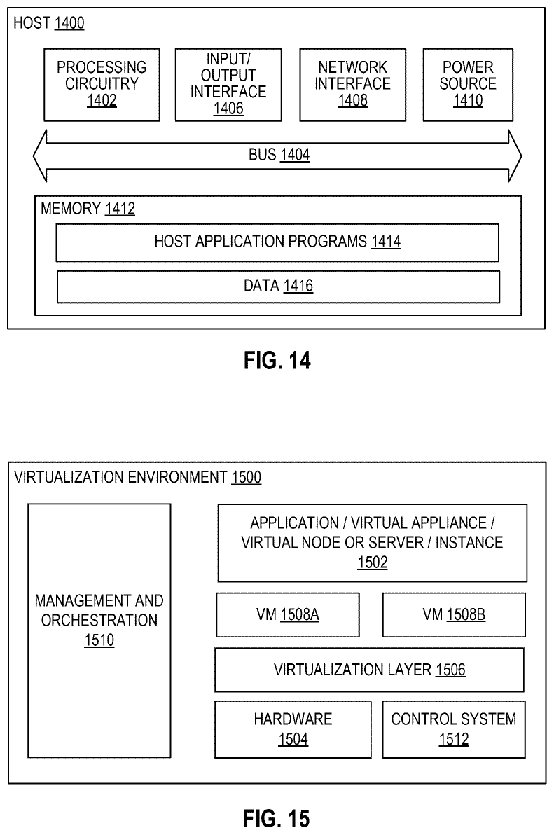

In FIG. 14 a block diagram of a host 1400, which may be an embodiment of the host 1116 of FIG. 11, in accordance with various aspects described herein.

As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more uEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of uEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

In FIG. 15 a block diagram illustrating a virtualization environment 1500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

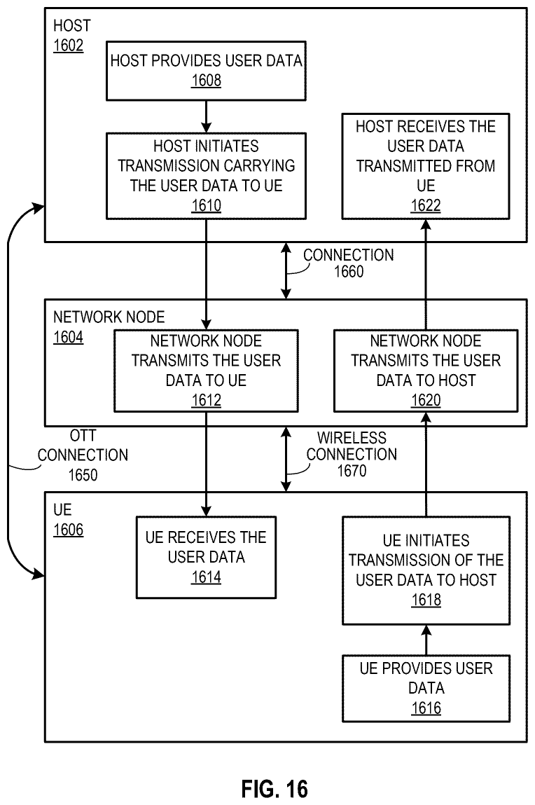

In FIG. 16 a communication diagram of a host 1602 communicating via a network node 1604 with a UE 1606 over a partially wireless connection in accordance with some embodiments.

Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the U′'s client application may receive request data from the hos′'s host application and provide user data in response to the request data. The OTT connection 1650 may transfer both the request data and the user data. The U′'s client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the latency and power consumption in the UE and provides an efficient solution to schedule multiple cells in carrier aggregation thereby improving the data transmission rates. As a result an OTT service benefits from higher data rates with simpler and therefore less expensive wireless devices. Better responsiveness and extended battery life due to reduced signalling and UE complexity can be offered for lower cost devices.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights).

As another example, the host 1602 may store surveillance video uploaded by a UE. As another example, the host 1602 may store or control access to media content such as video, audio, VR or AR which it can broadcast, multicast or unicast to uEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storⁱng, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., uEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

Example 1. A method performed by a wireless device for carrier aggregation with cross carrier scheduling, the method comprising: receiving a configuration for a first group of cells to be scheduled; receiving on a scheduling cell a downlink control information indicating two or more cells to be scheduled from the first group of cells.

Example 2. The method of example 1, further comprising: receiving a configuration for a plurality of groups of cells and wherein the downlink control information comprises an indication to one of the configured groups of cells.

Example 3. The method of example 2, wherein the configuration corresponds to a table and the indication in the downlink control information corresponds to a row of the table.

Example 4. The method of example 2 wherein the configuration comprises a radio resource control, RRC, message to provide an RRC scheduling set configuration comprising parameters corresponding to the entries of the table.

Example 5. The method of any of the preceding examples, wherein the indicated two or more cells are a subset of the configured first group of cells.

Example 6. The method of any of the above examples wherein the use of the bitfield in the downlink control information is determined according to; when an RRC scheduling set configuration is present, the bitfield is used in conjunction with the RRC configuration to determine the two or more cells from the first group of cells; and, when no RRC scheduling set configuration is present the bitfield is used as a bitmap to determine the two or more cells from the first group of cells.

Example 7. The method of example 6, wherein the RRC scheduling set configuration is only provided when the number of cells to be scheduled exceeds a fixed length of the bitfield of the downlink control information.

Example 8. The method of example 6 or 7, wherein when the bitfield is used as a bitmap, each bit position in the bitmap corresponds to one serving cell of the two or more cells.

Example 9. The method of example 8, wherein the least significant bit to the most significant bit are mapped to cells from the smallest to largest cellid.

Example 10. The method of any of the previous examples wherein the downlink control information comprises a carrier field length of 3 bits.

Example 11. The method of example 1, further comprising: receiving a configuration for a second group of cells to be scheduled, wherein the second group of cells is different from the first group and comprises different cells from the first group; receiving on the scheduling cell the downlink control information indicating two or more cells to be scheduled from one of the first group of cells and the second group of cells.

Example 12. The method of example 11 wherein the downlink control information comprises a carrier selection field for indicating one of the first group of cells and the second group of cells and a bitmap wherein one bit corresponds to a cell of the two or more cells to be scheduled.

Example 13. The method of example 12, wherein the downlink control information for the first group of cells has a first format and the downlink control information for the second group of cells has a second format, different from the first.

Example 14. The method of example 13, further comprising: detecting one of the first format and the second format in the same search space of the scheduling cell.

Example 15. The method of example 13 or 14, wherein at least one of the first format and the second format comprises a first field for indicating a set index, wherein the set index indicates an index associated with the first group of configured cells or with the second group of configured cells.

Example 16. The method of example 15, wherein at least one of the first format and the second format further comprises a second field for indicating the set of scheduled cells from the set of configured serving cells determined from the first field.

Example 17. The method of example 15 or 15, wherein the first field indicating a set index is included in the downlink control information format on a scheduling cell only when the number of groups of configured cells that can be scheduled is greater than one.

Example 18. The method of examples 15 to 17, wherein the first field indicating a set index is included in a format scheduling single cell when the downlink control information format is monitored on a scheduling cell that is also configured for transmission of a downlink control information format that schedules PDSCH/PUSCH resource assignments/grants on multiple cells.

Example 19. The method of examples 13 to 18, further comprising a cyclic redundancy check, CRC, sequence of the first format is scrambled with a first radio network temporary identifier, RNTI, and the CRC sequence of the second format is scrambled with a second RNTI.

Example 20. The method of examples 13 to 19, wherein the first and second RNTI are configured by higher layers, and/or he first and second RNTI are distinct from each other and/or at least one of the first DCI format and the second DCI format have distinct DCI payload sizes.

Example 21. The method of examples 13 to 20, wherein a size of at least one of the first format and the second format are indicated by higher layers.

Example 22. The method of example 21, wherein the size is indicated such that it is distinct between the formats to avoid having an explicit field.

Example 23. The method of example 13 to 22 wherein when a size of at least one of the first format payload and the second format payload size are equal, a set index field is included in the first and second DCI formats.

Example 24. The method of examples 13 to 23, wherein the search space for monitoring the downlink control information is based on at least the set index associated with the first set of cells or the second set of cells.

Example 25. The method of examples 13 to 24, wherein the search space is based on the carrier selector field associated with the set.

Example 26. The method of examples 13 to 25, wherein the downlink control information for scheduling the second group of cells is transmitted in the search space associated with the first group of cells.

Example 27. The method of any of the preceding examples, wherein the number of sets that UE can support is indicated via a UE capability signalling message.

Example 28. The method of any of the preceding examples, wherein when the group of cells which is configured for multi-cell scheduling comprises a primary cell which is the scheduling cell for the set, UE specific search space, USS, sets corresponding to a scheduling downlink control information for the set (DCI 0 X/1_X) are dropped in a search space overbooking procedure.

Example 29. The method of example 28, further comprising one or more of: RRC configuration of one or more set(s) of cells for DCI 0_X/1_X, respectively, and the scheduling cell and/or separate configuration for uplink and downlink DCI formats; configuration of search space for DCI 0_X/1_X on scheduling cell and a scheduled cell for each set, including separate search space for DCI 0_X and DCI 1_X; configuration of n_CI for each set of cells for use in the search space hashing function; configuration of DCI size for DCI 0_X/1_X for each set; configuration of DCI fields for DCI 0_X/1_X comprising one or more of configuration of subgroups among the group of cells, including maximum number of subgroups (up to 4); details of a joint time domain resource allocation, TDRA, configuration among the group of cells and/or comprising configuration of TDRA table used for PUSCH/PDSCH scheduling (per-cell per set of cells); details of a frequency domain resource allocation, FDRA, configuration and/or configuration of RBG size(s) used for PUSCH/PDSCH scheduling per-cell per set of cells; details of MCS configuration and/or comprising configuration of up to eight differential MCS offsets used for PUSCH/PDSCH scheduling per-cell per subgroup; redundancy version, RV, field size is explicitly configurable per cell.

Example 30. A method performed by a wireless device, the method comprising: any of the wireless device steps, features, or functions described above, either alone or in combination with other steps, features, or functions described above.

Example 31. The method of the previous example, further comprising one or more additional wireless device steps, features or functions described above.

Example 32. The method of any of the previous examples, further comprising: providing user data; and forwarding the user data to a host computer via the transmission to the base station.

Example 33. A method performed by a base station for scheduling a wireless device for carrier aggregation with cross carrier scheduling, the method comprising: transmitting a configuration for a first group of cells to be scheduled; transmitting on a scheduling cell a downlink control information indicating two or more cells to be scheduled from the first group of cells.

Example 34. The method of example 32, further comprising: transmitting a configuration for a plurality of groups of cells and wherein the downlink control information comprises an indication to one of the configured groups of cells.

Example 35. The method of example 33, wherein the configuration corresponds to a table and the indication in the downlink control information corresponds to a row of the table.

Example 36. The method of example 33 wherein the configuration comprises a radio resource control, RRC, message to provide an RRC scheduling set configuration comprising parameters corresponding to the entries of the table.

Example 37. The method of any of examples 33-35, wherein the indicated two or more cells are a subset of the configured first group of cells.

Example 38. The method of examples 33-36, wherein the RRC scheduling set configuration is only provided when the number of cells to be scheduled exceeds a fixed length of the bitfield of the downlink control information.

Example 39. The method of example 33-37 wherein when an RRC scheduling set configuration is transmitted, the bitfield is used in conjunction with the RRC configuration to determine the two or more cells from the first group of cells; and when no RRC scheduling set configuration is present the bitfield is configured as a bitmap to explicitly identify the two or more cells from the first group of cells.

Example 40. The method of example 38 wherein when the bitfield is used as a bitmap, each bit position in the bitmap corresponds to one serving cell of the two or more cells.

Example 41. The method of example 39, wherein the least significant bit to the most significant bit are mapped to cells from the smallest to largest cellid.

Example 42. The method of example 32, further comprising: transmitting a configuration for a second group of cells to be scheduled, wherein the second group of cells is different from the first group and comprises different cells from the first group; transmitting on the scheduling cell the downlink control information indicating two or more cells to be scheduled from one of the first group of cells and the second group of cells.

Example 43. The method of example 41 wherein the downlink control information comprises a carrier selection field for indicating one of the first group of cells and the second group of cells and a bitmap wherein one bit corresponds to a cell of the two or more cells to be scheduled.

Example 44. The method of example 42, wherein the downlink control information for the first group of cells has a first format and the downlink control information for the second group of cells has a second format, different from the first.

Example 45. The method of example 43, further comprising transmitting one of the first format and the second format in the same search space of the scheduling cell.

Example 46. The method of example 43 or 44, wherein at least one of the first format and the second format comprises a first field for indicating a set index, wherein the set index indicates an index associated with the first group of configured cells or with the second group of configured cells.

Example 47. The method of example 43 or 44, wherein at least one of the first format and the second format further comprises a second field for indicating the set of scheduled cells from the set of configured serving cells determined from the first field.

Example 48. The method of example 45 or 46, wherein the first field indicating a set index is included in the downlink control information format on a scheduling cell only when the number of groups of configured cells that can be scheduled is greater than one.

Example 49. The method of examples 43 to 17, wherein the first field indicating a set index is included in a format scheduling single cell when the downlink control information format is monitored on a scheduling cell that is also configured for transmission of a downlink control information format that schedules PDSCH/PUSCH resource assignments/grants on multiple cells.

Example 50. A method performed by a base station, the method comprising: any of the steps, features, or functions described above with respect to base station, either alone or in combination with other steps, features, or functions described above.

Example 51. The method of the previous example, further comprising one or more additional base station steps, features or functions described above.

Example 52. The method of any of the previous examples, further comprising: obtaining user data; and forwarding the user data to a host computer or a wireless device.

Example 53. A mobile terminal comprising: processing circuitry configured to perform any of the steps of any of the examples 1 to 29; and power supply circuitry configured to supply power to the wireless device.

Example 54. A base station comprising: processing circuitry configured to perform any of the steps of any of the examples 33 to 49; power supply circuitry configured to supply power to the wireless device.

Example 55. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the examples 1 to 29; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example 56. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of the examples 33 to 49.

Example 57. The communication system of the previous example further including the base station.

Example 58. The communication system of the previous 2 examples, further including the UE, wherein the UE is configured to communicate with the base station.

Example 59. The communication system of the previous 3 examples, wherein: the processing circuitry of the host computer is configured to execute a host application, thereby providing the user data; and the UE comprises processing circuitry configured to execute a client application associated with the host application.

Example 60. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of the examples 33 to 49.

Example 61. The method of the previous example, further comprising, at the base station, transmitting the user data.

Example 62. The method of the previous 2 examples, wherein the user data is provided at the host computer by executing a host application, the method further comprising, at the UE, executing a client application associated with the host application.

Example 63. A user equipment (UE) configured to communicate with a base station, the UE comprising a radio interface and processing circuitry configured to performs any of the previous 3 examples.

Example 64. A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of the Group A examples.

Example 65. The communication system of the previous example, wherein the cellular network further includes a base station configured to communicate with the UE.

Example 66. The communication system of the previous 2 examples, wherein: the processing circuitry of the host computer is configured to execute a host application, thereby providing the user data; and the UE's processing circuitry is configured to execute a client application associated with the host application.

Example 67. A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of the examples 1 to 29.

Example 68. The method of the previous example, further comprising at the UE, receiving the user data from the base station.

Example 69. A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of the examples 1 to 29.

Example 70. The communication system of the previous example, further including the UE.

Example 71. The communication system of the previous 2 examples, further including the base station, wherein the base station comprises a radio interface configured to communicate with the UE and a communication interface configured to forward to the host computer the user data carried by a transmission from the UE to the base station.

Example 72. The communication system of the previous 3 examples, wherein: the processing circuitry of the host computer is configured to execute a host application; and the UE's processing circuitry is configured to execute a client application associated with the host application, thereby providing the user data.

Example 73. The communication system of the previous 4 examples, wherein: the processing circuitry of the host computer is configured to execute a host application, thereby providing request data; and the UE's processing circuitry is configured to execute a client application associated with the host application, thereby providing the user data in response to the request data.

Example 74. A method implemented in a communication system including a host computer, a base station and a user equipment (UE), the method comprising: at the host computer, receiving user data transmitted to the base station from the UE, wherein the UE performs any of the steps of any of the examples 1 to 29.

Example 75. The method of the previous example, further comprising, at the UE, providing the user data to the base station.

Example 76. The method of the previous 2 examples, further comprising: at the UE, executing a client application, thereby providing the user data to be transmitted; and at the host computer, executing a host application associated with the client application.

Example 77. The method of the previous 3 examples, further comprising: at the UE, executing a client application; and at the UE, receiving input data to the client application, the input data being provided at the host computer by executing a host application associated with the client application, wherein the user data to be transmitted is provided by the client application in response to the input data.

Example 78. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the examples 33 to 49.

Example 79. The communication system of the previous example further including the base station.

Example 80. The communication system of the previous 2 examples, further including the UE, wherein the UE is configured to communicate with the base station.

Example 81. The communication system of the previous 3 examples, wherein: the processing circuitry of the host computer is configured to execute a host application; the UE is configured to execute a client application associated with the host application, thereby providing the user data to be received by the host computer.

Example 82. A method implemented in a communication system including a host computer, a base station and a user equipment (UE), the method comprising: at the host computer, receiving, from the base station, user data originating from a transmission which the base station has received from the UE, wherein the UE performs any of the steps of any of the examples 1 to 29.

Example 83. The method of the previous example, further comprising at the base station, receiving the user data from the UE.

Example 84. The method of the previous 2 examples, further comprising at the base station, initiating a transmission of the received user data to the host computer.

In RAN #94, it was agreed to start a Rel 18 WI on multi-carrier enhancements, with the following objectives for multi-cell PUSCH/PDSCH scheduling (one PDSCH/PUSCH per cell) with a single DCI.

Specify a solution for multi-cell PUSCH/PDSCH scheduling
(one PDSCH/PUSCH per cell) with a single DCI [RAN1]

Identify the maximum number of cells that can be scheduled
simultaneously
Consider both intra-band and inter-band CA operation
Consider both FR1 and FR2
The single DCI shall be optimized for 3 or more cells for the multi-cell
PUSCH/PDSCH scheduling

In RAN #97, MCE WI down-scoping was discussed, and below is the outcome. Several aspects related to mc-DCI design were down-scoped.
Rel-18 Multicarrier Enhancement (revised WID RP-222251)
   Clarify in revised WD RP-222251 that the number of TAGs is limited to up to 2 for both 2 bands switching and more than 2 bands switching oases.
      For the work on UL Tx switching with 2 TAGs. RAN1/2 discussion can be triggered by RAN4 LS. No RAN1 spec impact is expected.
   Deprioritize any optimization for unlicensed spectrum operation for designing the multi-cell PUSCH/PDSCH scheduling n Rel-18
   Enhanced Type-2 HARQ-ACK codebook is not supported for the multi-cell PUSCH/PDSCH scheduling in Rel-18.
   Type-1 HARQ-ACK codebook is supported only for the case where co-scheduled cells by a DCI format 1_X have same SCS/carrier type/duplex mode in Rel-18. Additional restriction(s) can be discussed in RAN1
   Configuring more than one scheduling cell for DCI format 0_X/1_X for each scheduled cell is not supported for the multi-cell PUSCH/PDSCH scheduling in Rel-18
   Following aspects are excluded from multi-cell PDSCH/PUSCH scheduling in Rel-18:
      SCell schedules multiple cells including P(S)Cell
      Different SCS among co-scheduled cells
      Different carrier type (licensed or unlicensed, FR1 or FR2-1 or FR2-2) among co-scheduled cells
      Configuration of both multi-cell PDSCH/PUSCH scheduling and multi-TRP for a scheduled cell
      Support for any sidelink scheduling
      PCell schedules multiple cells by DCI format 0_X/1_X when a sSCell is configured to schedule PCell

In an example discussion paper, various aspects considered for specifying this feature. The agreements on this topic so far are listed below.

### DISCUSSION

In NR releases until Rel-17, a single DCI can schedule PUSCH/PDSCH on one cell and single DCI can schedule multiple PUSCH/PDSCH on single cell. The new Rel-18 WI objective is to specify a feature where a single DCI can be used for multi-cell PUSCH/PDSCH scheduling (one PUSCH/PDSCH per cell).

### High-Level Design Aspects

In current framework, a PDCCH can schedule PDSCH on only one cell using DCI formats 1-0/1-1/1-2. In case of self-carrier scheduling, the PDCCH and PUSCH/PDSCH are received on the same serving cell. For cross-carrier scheduling, a PDCCH is received on a scheduling cell (cell A) and the corresponding PUSCH/PDSCH may be received on a scheduled cell which may be same as the scheduling cell (cell A) or on another cell (cell B).

For single DCI scheduling PUSCH/PDSCH on multiple cells, one PDCCH DCI format on the scheduling cell (e.g. cell A) has to schedule a PUSCH/PDSCH e.g. for the scheduling cell (cell A) and also one other PUSCH/PDSCH for another scheduled cell (cell B). As stated in the WID justification, trade-off between overhead saving and scheduling restriction must be taken into account.

CA is a native feature of NR supported from Rel15 and it is used for aggregating carriers with a wide variety of attributes depending on the specific deployment scenario. This flexibility provided by CA should be retained even when single DCI scheduling PUSCH/PDSCH on multiple cells (or mc-DCI) is used.

### Maximum Number of Cells Scheduled by Mc-DCI

Below WA was made in RAN1 #110-e. The value of 4 provides the correct balance between DCI overhead reduction and the scheduling restriction. Hence, the working assumption with value 4 can be confirmed.

An FFS was added for maximum number of configurable cells for co-scheduling. In a simple case, the maximum number of configurable cells for co-scheduling can also be 4.

There can be other possibilities, for example, the maximum number of configured cells is 8 (i.e., larger than 4), but only 4 cells can be co-scheduled by a mc-DCI. In such a case, considering full carrier scheduling, two mc-DCIs are needed within a slot to be able to simultaneously schedule all eight carriers. It can become easily complicated if the carrier grouping indication in the DCIs keeps varying assuming at every scheduling instance, there is flexibility to group the eight carriers into up to two DCIs. At this point in the WI phase, it is preferrable to use the simple option of using 4 also for maximum number of configurable cells. Then for case with 8 carriers, two groups, each group with 4 configured cells can be used for mc-DCI scheduling. Example is shown in

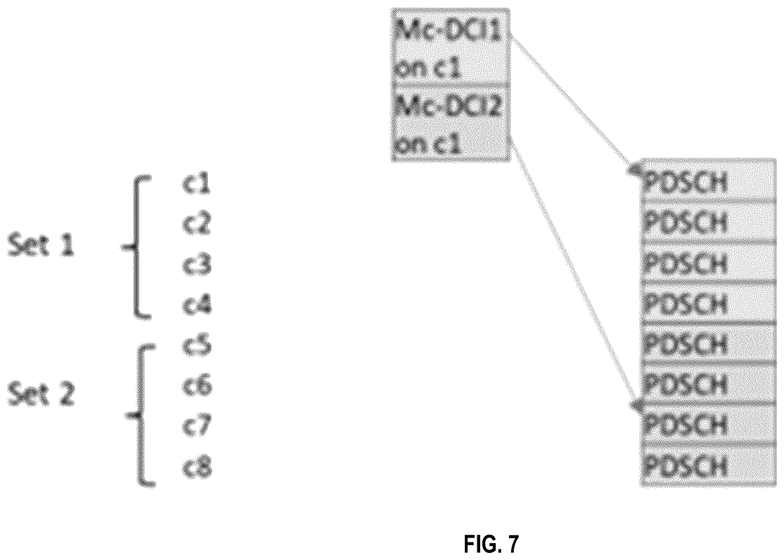

FIG. 7, scheduling eight cells using two sets of four cells each from one scheduling cell.

### Working Assumption

The maximum number of co-scheduled cells by a DCI format 1X in Rel-18 is 4.
The maximum number of co-scheduled cells by a DCI format 0_X in Rel-18 is 4.
   FFS: The maximum number of configurable cells for co-scheduling
Proposal 1 For a set of cells which is configured for multi-cell scheduling, maximum number of cells with the set is four.
   Maximum number of sets of cells is four.

### DCI Size Handling and Budgets

Next, we discuss DCI size handling and budgets. Following WA was made in last RAN1 meeting.

### Working Assumption

For a set of cells which is configured for multi-cell scheduling,
Existing DCI size budget is maintained on each cell of the set of cells.
DCI size of DCI format 0_X/1_X is counted on one cell among the set of cells.
   FFS which cell DCI size of the DCI format 0 X/1_X is counted on.
BD/CCE of DCI format 0_X/1_X is counted on one cell among the set of cells.
   FFS which cell BD/CCE of the DCI format 0_X/1_X is counted on.
Search space of DCI format 0 X/1_X is configured on one cell of the set of cells and associated with the search space of the scheduling cell with the same search space ID.
   FFS which cell the SS of the DCI format 0_X/1_X is configured on.
FFS: How to address Rel-17 BD/CCE limit for any given cell (operating the feature under Rel-17 BD/CCE limit)
Note: This does not mean a UE is required to support number ofBDs/CCEs beyond the Rel-17 limits (i.e.,

$${M}_{PDCCH}^{max , slot , μ} , {C}_{PDCCH}^{max , slot , μ} , {M}_{PDCCH}^{total , slot , μ} and {C}_{PDCCH}^{total , slot , μ} )$$

for PDCCH candidates for each scheduled cell.

mc-DCI configuration for uplink and downlink should also be addressed. Typically, the number of aggregated carriers can be different between downlink and uplink. Moreover, it is possible (and perhaps more likely) that the DCI size for downlink and uplink is different. In such a case, it is preferable to keep independent the configuration of mc-DCI for PUSCH and PDSCH as well as to configure the BDs for those separately. For example, if UE is configured with four cells in downlink and only two cells (or even one cell) in the uplink, then a mc-DCI for downlink makes sense, but there may be no need to use mc-DCI for the uplink or perhaps assign separate BDs for mc-DCI for uplink and downlink.

In case a scheduling cell is configured to schedule more than one set of cells for 0_X/1_X (as shown in FIG. 1), a set index field can also be included in the DCI. This is strictly not essential as the size distinction can be easily handled by higher layer configuration of size of mc-DCI.

Since existing DCI size budgets are maintained for each scheduled cell, the DCI size counting on only one cell may also be simplified. However, in case one cell in case of DCI size is necessary to be identified, it can be cell amongst the set of cells which has the lowest cell index, and which is not a scheduling cell for the DCI 0_X/1_X.

Below figure shows an example of the DCI size handling issue. If c1 is the scheduling cell and c1, c2, c3,c4 belong a set, then some example payload sizes are shown in the table below, wherein some payload sizes are also shown in unbolded font. For c1->c1, since DCI 1-X and DCI 0-X have 80- and 70-bits payload each, the existing DCI size budget may be exceeded. In this case it is simpler to explicitly configure the payload of DCI 0_X/1_X explicitly e.g. to 80 bits. Then, following existing specification, DCI size matching adjusts the sizes of DCI 1_1 and DCI 0_1 to be 60 bits for c1->c1. Thus, all size budgets can be satisfied very easily with unnecessary specification update for DCI size alignment of 38.212.

TABLE 1
Illustration of DCI size budget handling for mc-DCI.

| | DCI size (in bold) | | | | |
|---|---|---|---|---|---|
| | 0-0/1-0 | 1-1 | 0-1 | 1-X | 0-X |
| c1 -> c1 | 50 | 55 -> 60 | 60 | 80 -> 80 | 70 -> 80 |
| c1 -> c2 | | 56 | 61 | 80 -> 80 | 70 -> 80 |
| c1 -> c3 | | 57 | 62 | 80 -> 80 | 70 -> 80 |
| c1 -> c4 | | 58 | 63 | 80 -> 80 | 70 -> 80 |

Based on above, the below proposals are made.
Proposal 2 For each set, size of mc-DCI (0_X/1_X) is explicitly configured by higher layers.
Proposal 3 For each set, support independent configuration of mc-DCI for PUSCH and PDSCH.
Proposal 4 DCI size of DCI format 0_X/1_X is counted on the cell amongst the set of cells which has the lowest cell index, and which is not a scheduling cell for the DCI 0_X/1_X.
Proposal 5 When a scheduling cell is configured to carry DCI format 1_X/0_X for more than one set of configured co-schedulable cells, a set index field is included in the DCI format 1_X/0_X for the scheduling cell.

### BD Handling/Budgets

Using DCI 0_X/1_X, a single BD/CCE candidate can schedule PDSCH/PUSCH on multiple cells, thereby reducing UE BD complexity. Of course, since a single BD/CCE candidate can schedule multiple cells in a set, the BD/CCE budget can be redistributed to allocate more BDs to other carriers not in the set. However, whether and how to do such redistribution needs strong motivation, especially if it leads to increased UE BDs and spec complexity.

For a scheduled cell, it should be possible to configure a same number of BD/CCEs for monitoring scheduling DCI formats (including 0_X/1_X and legacy DCI formats) as the case of legacy cross-carrier scheduling.

Consider an example. UE is configured with a primary cell with 15 kHz SCS and four sCells with 30 kHz SCS and the UE indicates a pdcch-BlindDetectionCA capability of

$${N}_{cells}^{cap} = 4.$$

Case 1A: Assume all four sCells are cross-carrier scheduled from the primary cell using legacy mechanism (i.e. Rel-16 cross-carrier scheduling). The primary cell schedules itself using legacy DCI formats.

Case 1B: Assume all four sCells are co-scheduled by mc-DCI and/or legacy DCI formats from the primary cell (i.e. Rel-18 cross-carrier scheduling). The primary cell schedules itself using legacy DCI formats.

For case 1A, according to legacy, for the 15 kHz (μ=0),

$${M}_{PDCCH}^{total , slot , μ} = ⌊ 4 \times 44 \times 1 / 5 ⌋ = 35 ,$$

$${C}_{PDCCH}^{total , slot , μ} = ⌊ 4 \times 56 \times 1 / 5 ⌋ = 44$$

and for the 30 kHz (μ=1),

$${M}_{PDCCH}^{total , slot , μ} = ⌊ 4 \times 36 \times 4 / 5 ⌋ = 115 ,$$

$${C}_{PDCCH}^{total , slot , μ} = ⌊ 4 \times 56 \times 4 / 5 ⌋ = 179.$$

### Thus,

for the 15 kHz primary cell, the UE can be configured with up to 35 BDs with maximum of 44 non-overlapped CCEs per slot of scheduling cell.
for the 30 kHz serving cells,
the UE can be configured with an aggregate (across all four sCells) of maximum of 115 BDs and maximum of 179 non-overlapped CCEs per slot of scheduling cell,
and a per-cell limit of 36 BDs and 56 CCEs per slot of the scheduling cell.

Now consider case 1B. The existing budget limits can still be applicable. This is shown in

FIG. 8, where Legacy CCS limits in case 1A are depicted in the left had side, and limits for mc-DCI based CCS in Case 1B are depicted in the right hand side.

From UE point of view, if it is only configured with mc-DCI formats for Pcell->Scell CCS for case 1B, then the UE can be configured with at most 36 BDs altogether for the four sCells. In that case, the upper limit of 115 BDs aggregate over four sCells should be irrelevant. Duplicate counting of each BD four times (once in each cell) gives 4*36=144 BDs which exceed 115 BDs and such duplicate counting may be meaningless and should be avoided.

Another example, if UE is configured with mc-DCI formats and legacy DCI formats for Pcell->Scell CCS for case 1B, then if the UE can be configured with at most 20 BDs for mc-DCI, then UE can be configured with a maximum of 16 additional BDs per sCell to satisfy both the aggregate limit (4*16+20<=115) and per-cell limit (16+20<=36). Again, duplicate counting of each mc-DCI four times (once in each cell) gives 4*16+4*20=144 BDs and this should be avoided.

Overall, the main thing to avoid is to counting the same BD attempt for a mc-DCI, when counting BD/CCE for comparison against the aggregate limits

$${M}_{PDCCH}^{total , slot , μ} and {C}_{PDCCH}^{total , slot , μ} ,$$

avoid counting the same BD attempt for a mc-DCI multiple times.

Duplicate counting of a BD/CCE attempt for a mc-DCI format should be avoided when counting BD/CCE across co-scheduled cells for comparison against the aggregate limits

$${M}_{PDCCH}^{total , slot , μ} and {C}_{PDCCH}^{total , slot , μ} .$$

An example configuration that should be possible is shown in below figure. For mc-DCI the UE can be configured with 20 BDs, while for CCS using legacy DCI, 16 BDs can be configured, from pcell to scell1, and so on. This yields maximum 36 BDs per scheduled sCell, and a total of 16*4+20=84 BDs for scheduled cells of 30 kHz SCS.

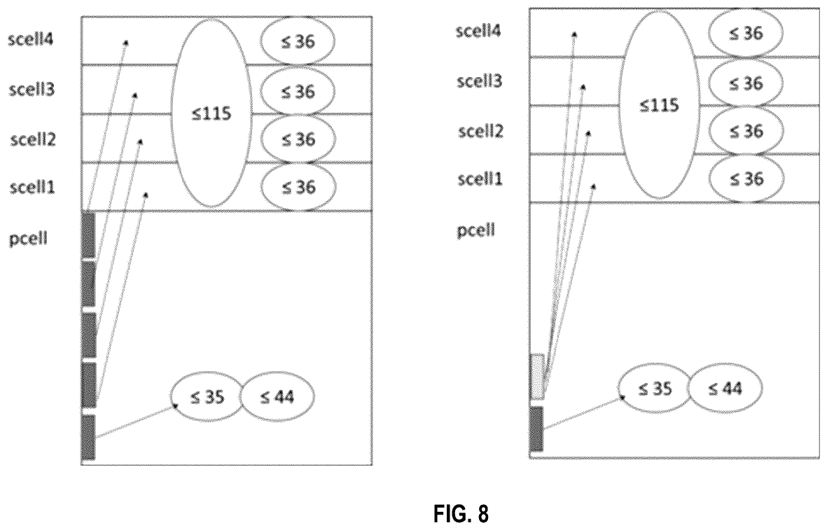

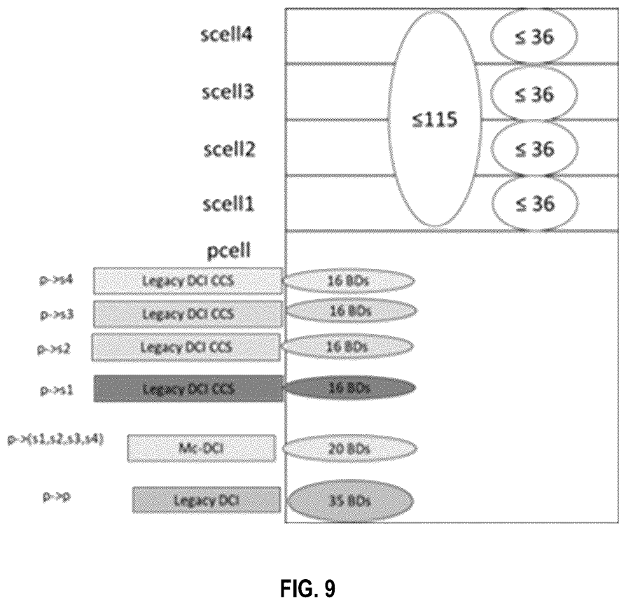

In FIG. 9, for Case 1B, configuration of BDs for the different DCI formats is shown. 16 BDs is for legacy DCI CCS from pcell to scell1.

Therefore, in our view, the existing spec limits work for DCI 0_X/1_X also, but update is needed to avoid the duplicate counting issue. Therefore, we propose the following.
Proposal 6 BD/CCE counting for mc-DCI is based on the legacy Rel-15/16/17 BD/CCE counting mechanism with the following update
   a BD/CCE attempt for a mc-DCI format is counted only once for comparison against aggregate

$${M}_{PDCCH}^{total , slot , μ} and {C}_{PDCCH}^{total , slot , μ}$$

limits in numerology buckets.

One more issue is regarding handling of BDs of DCI 0_X/1_X in the overbooking procedure when the primary cell belongs to a set of cells and is the scheduling cell for the set. For overbooking, the USS for 0_X/1_X can be treated as one of below options. While either option works, it seems straight-forward to allow dropping.
Option 1: Allow dropping (e.g. like a pCell USS set)
Option 2: No dropping (e.g. like a sCell USS set)
Proposal 7 For a set of cells which is configured for multi-cell scheduling, if the primary cell belongs to the set and is a scheduling cell for the set, USS sets corresponding to DCI 0_X/1_X for the set can be dropped in search space overbooking procedure.

### Search Space Configuration and Definition

For mc-DCI, the search space linking needs to be specified, especially which the cell contains the linked search space configuration. It is simpler to say that linked search space set is configured on the lowest cell index of the group of cells indicated by the mc-DCI. Below figure shows an example of search space linking, where a single scheduling cell can schedule two DL/UL mc-DCIs, one for Group1 and one for Group2. When the linked search space ends up on the scheduling cell (because it is the lowest indexed cell), then the linking should be transparent, and the search space for DCI 0_X/1_X on the scheduling cell would contain the full search space configuration.

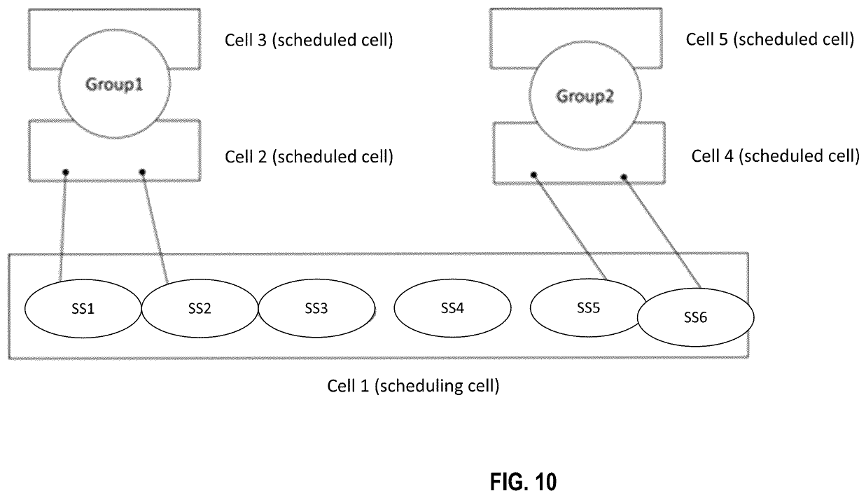

FIG. 10 is an illustration showing linked search space where cell 1 is used to schedule DCI 0_X/1_X for two groups (cells 2 and 3, and cells 4 and 5 respectively): search space 1 (SS1) comprises DCI 1-X, GRP1; search space 2 (SS2) comprises DCI 0-X, GRP1; search space 3 (SS3) comprises DCI 1-1/0-1; search space 4 (SS4) comprises DCI 1-1/0-1; search space 5 (SS5) comprises DCI 1-X, GRP2; and search space 6 (SS6) comprises DCI 0-X, GRP2.
Proposal 8 Search space of DCI format 0_X/1_X is configured on the cell amongst the set of cells which has the lowest cell index.
   Note: When cell with lowest cell index within a set is same as the scheduling cell, the corresponding search space on scheduling cell for DCI format 0_X/1_X has the full search space configuration.

Search space in which mc-DCI is monitored needs to be specified. From the spec, the search space is determined as follows. For mc-DCI, most parameters are setup via search space configuration (BDs/CCEs/coresets, etc). However, the n_CI parameter needs to be discussed. n_CI is given by the CIF field for legacy CCS. For mc-DCI, n_CI needs to be selected.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i$$

Consider the case where a UE is configured to monitor both mc-DCI and legacy DCI for a scheduled cell.

For legacy DCI, n_CI is given by the carrier indicator field configured for CCS from the scheduling cell to the scheduled cell. We do not see need to change that.

For mc-DCI, it is simple if n_CI is explicitly configured by higher layers. Since a group of cells would be configured to be co-scheduled by a mc-DCI, a corresponding n_CI value can also be configured for that group of cells.
Proposal 9 For monitoring DCI 0_X/1_X PDCCH candidates for a set of cells, the n_CI to be used in the search space equation is explicitly configured for the set of cells.

### RRC Parameters

At least the following is needed:
Configuration of one or more set(s) of cells for DCI 0_X/1_X, respectively, and the scheduling cell Separate configuration for uplink and downlink DCI formats
Configuration of search space for DCI 0_X/1_X on scheduling cell and a scheduled cell for each set, including separate search space for DCI 0_X and DCI 1_X
Configuration of n_CI for each set of cells for use in the search space hashing function
Configuration of DCI size for DCI 0_X/1_X for each set
Configuration of DCI fields for DCI 0_X/1_X
Configuration of subgroups among the set of cells, including maximum number of subgroups (up to 4)
Details of joint TDRA configuration among the set of cells
configuration of TDRA table used for PUSCH/PDSCH scheduling (per-cell per set of cells) Details of FDRA configuration
configuration of RBG size(s) used for PUSCH/PDSCH scheduling (per-cell per set of cells) Details of MCS configuration
configuration of up to eight differential MCS offsets used for PUSCH/PDSCH scheduling (per-cell per subgroup) RV field size is explicitly configurable per cell (0/1/2 bits)

### Mc-DCI Format Design

Below reformulation was agreed in RAN1 #110-e meeting.

### Agreement

For discussing field design of DCI format 0_X/1_X which schedules more than one cell, reformulate the types of DCI fields as below:
Type-1 field:
   Type-1A field: A single field indicating common information to all the co-scheduled cells
   Type-1B field: A single field indicating separate information to each of co-scheduled cells via joint indication
   Type-1C field: A single field indicating an information to only one of co-scheduled cells
Type-2 field: Separate field for each of the co-scheduled cells
Type-3 field: Common or separate to each of the co-scheduled cells, or separate to each sub-group, dependent on explicit configuration.
   Note: One sub-group comprises a subset of co-scheduled cells where a single field is commonly applied to the co-scheduled cell(s) belonging to a same sub-group.
Note: Handling of any parameters applicable to multi-cell scheduling where corresponding fields are not included in DCI format 0 X/1_X (if any) will be separately discussed.

Furthermore, the following progress was made on DCI 0_X/1_X design.

### Agreement

For DCI format 1_X/0_X which can schedule more than one cell,
Type-1 fields at least include below:
   Type-1A:
      Identifier for DCI formats
      Downlink assignment index
      TPC for scheduled PUCCH
      PUCCH resource indicator
      PDSCH-to-HARQ timing indicator
      One-shot HARQ-ACK request
Type-2 fields at least include below:
   New data indicator per TB
   Redundancy version per TB
FFS: Other fields to be included in DCI format 1_X/0_X and which type of the fields belongs to.
FFS: size for each field

Below we list some aspects that need to be considered for mc-DCI. We note the high-level aspects (as discussed in previous sections) would influence the detailed design of mc-DCI. Nonetheless, some principles for mc-DCI design and simplifications (for certain fields such as UL-related information for PDSCH) are discussed in below.

It needs to be discussed whether mc-DCI format supports the functionality of all the DCI fields specified for existing DCI formats (i.e. 1_1/1_2/0_1/0_2) or whether it supports only a limited subset of DCI fields.

mc-DCI design should be able to maintain scheduling flexibility as much as possible, while compress the DCI information for up to 4 cells. Some fields can be grouped together, e.g. in case of intra-band carriers, while some other fields may still remain separate per-cell.

A field in DCI is needed to indicate the scheduled carriers. If the maximum number of scheduled cells is four, then a simple option for indicating the scheduled carriers is an explicit bitmap, wherein each bit indicates whether the DCI schedules PUSCH/PDSCH for the corresponding cell. Configuring a look up table could be done if scheduling a larger number of cells but given the maximum number of configurable cells is 4, bitmap seems sufficient.
Proposal 10 A carrier selection field (CSF) is introduced for indication of co-scheduled cells by DCI format 0_X/1_X, wherein the field is a bitmap corresponding to the set of configured cells that can be scheduled by the DCI format.

Higher layers configure a group of cells that are scheduled by a single mc-DCI using a scheduling cell. The group of cells may be further divided into one or more subgroups (e.g. a subgroup may represent intra-band carriers and different subgroups may represent inter-band). Note that if there is only one cell per subgroup, then the subgroup specific field becomes same as individual cell-specific field. The DCI fields can then be characterized into:
Common field DCI field jointly indicates functionalities for all the scheduled cells
   E.g. carrier selection information
Sub-group specific field DCI field jointly indicates functionalities for a subset of the scheduled cells, for example the subset may correspond to intra-band carriers
   E.g. rate-matching indicator, TDRA
Individual cell-specific field Separate DCI fields are needed for each PUSCH/PDSCH
   E.g. NDI

For mc-DCI, at least the following fields should be applicable for each subgroup of cells scheduled by mc-DCI
TDRA
VRB-to-PRB mapping
PRB bundling size indicator
Rate matching indicator
ZP CSI-RS trigger
Antenna port(s)
Transmission configuration indication
DM-RS sequence initialization
BWP

FDRA is one of the largest fields in the DCI format and the balance between the flexibility and size should be considered for FDRA in the mc-DCI design. Our preference is to retain the flexibility to indicate different PRB assignments for the cells scheduled by mc-DCI. However, to reduce overhead, larger RBG size can be used for the PRB allocations. The RBG size to use for mc-DCI can be configured individually for the scheduled cells.

For Type 1 FDRA, similar approach as that adopted for DCI format 0_2/1_2 can be used to reduce overhead. Further, 1 there is overhead when encoding the RIV as a binary number. There are N_{PRB}·(N_{PRB}+1)/2 different RIVs for a carrier with N_{PRB} PRBs. Since this is not a power of 2 in general there is an overhead of up to 1 bit when encoding this as a binary number in the FDRA field. This overhead accumulates when having several RIVs for several carriers. If the RIVs are jointly encoded before being converted into binary, up to N−1 bits can be saved when scheduling N carriers.
Proposal 11 For each cell, support separate configuration of RBG size(s) used for PUSCH/PDSCH scheduling using mc-DCI.
Proposal 12 For frequency domain resource allocation (FDRA) using mc-DCI, support joint coding of individual RIVs of each cell to reduce overhead for FDRA type 1.

RV field can be configurable to reduce overhead.
Proposal 13 For mc-DCI, RV field size is explicitly configurable per cell (0/1/2 bits).

MCS index is five bits per TB. Thus, for four carriers with up to 2 TBs each, there can be 5*2*4=40 bits occupied by MCS, which would be too large. Our preference is to allow compressed MCS indication while retaining some flexibility to indicate different MCS indications. Typically, this would allow better flexibility in case of intra-band cases and hence to be supported for case with subgrouping.
Proposal 14 For mc-DCI, support joint coding of MCS indication for co-scheduled cells in a subgroup
   MCS index for a first cell is five bits (Index 1), and for each of remaining cells in the subgroup, differential MCS index is indicated relative to the Index 1.
   For each of the remaining cells, up to 3 bits for differential MCS index, and the differential MCS offsets are configured by higher layers.

### CONCLUSION

In the previous sections we made the following observations:
Observation 1 For a scheduled cell, it should be possible to configure a same number of BD/CCEs for monitoring scheduling DCI formats (including 0_X/1_X and legacy DCI formats) as the case of legacy cross-carrier scheduling.
Observation 2 Duplicate counting of a BD/CCE attempt for a mc-DCI format should be avoided when counting BD/CCE across co-scheduled cells for comparison against the aggregate limits MPDCCHtota1,slot,μ and CPDCCHtota1,slot,μ.

Based on the discussion in the previous sections we propose the following:
Proposal 1 For a set of cells which is configured for multi-cell scheduling, maximum number of cells with the set is four.
   Maximum number of sets of cells is four.
Proposal 2 For each set, size of mc-DCI (0_X/1_X) is explicitly configured by higher layers.
Proposal 3 For each set, support independent configuration of mc-DCI for PUSCH and PDSCH.
Proposal 4 DCI size of DCI format 0_X/1_X is counted on the cell amongst the set of cells which has the lowest cell index, and which is not a scheduling cell for the DCI 0_X/1_X.
Proposal 5 When a scheduling cell is configured to carry DCI format 1_X/0_X for more than one set of configured co-schedulable cells, a set index field is included in the DCI format 1_X/0_X for the scheduling cell.
Proposal 6 BD/CCE counting for mc-DCI is based on the legacy Rel-15/16/17 BD/CCE counting mechanism with the following update
   a BD/CCE attempt for a mc-DCI format is counted only once for comparison against aggregate MPDCCHtota1,slot,μ and CPDCCHtota1,slot,μ limits in numerology buckets.
Proposal 7 For a set of cells which is configured for multi-cell scheduling, if the primary cell belongs to the set and is a scheduling cell for the set, USS sets corresponding to DCI 0_X/1_X for the set can be dropped in search space overbooking procedure.
Proposal 8 Search space of DCI format 0_X/1_X is configured on the cell amongst the set of cells which has the lowest cell index.
   Note: When cell with lowest cell index within a set is same as the scheduling cell, the corresponding search space on scheduling cell for DCI format 0_X/1_X has the full search space configuration.
Proposal 9 For monitoring DCI 0_X/1_X PDCCH candidates for a set of cells, the n_CI to be used in the search space equation is explicitly configured for the set of cells.
Proposal 10 A carrier selection field (CSF) is introduced for indication of co-scheduled cells by DCI format 0_X/1_X, wherein the field is a bitmap corresponding to the set of configured cells that can be scheduled by the DCI format.
Proposal 11 For mc-DCI, at least the following fields should be applicable for each subgroup of cells scheduled by mc-DCI
   TDRA
   VRB-to-PRB mapping
   PRB bundling size indicator
   Rate matching indicator
   ZP CSI-RS trigger
   Antenna port(s)
   Transmission configuration indication
   DM-RS sequence initialization
   BWP
Proposal 12 For each cell, support separate configuration of RBG size(s) used for PUSCH/PDSCH scheduling using mc-DCI.
Proposal 13 For frequency domain resource allocation (FDRA) using mc-DCI, support joint coding of individual RIVs of each cell to reduce overhead for FDRA type 1.
Proposal 14 For mc-DCI, RV field size is explicitly configurable per cell (0/1/2 bits).
Proposal 15 For mc-DCI, support joint coding of MCS indication for co-scheduled cells in a subgroup
   MCS index for a first cell is five bits (Index 1), and for each of remaining cells in the subgroup, differential MCS index is indicated relative to the Index 1.
   For each of the remaining cells, up to 3 bits for differential MCS index, and the differential MCS offsets are configured by higher layers.

1.-36. (canceled)

37. A method performed by a wireless device for carrier aggregation with cross carrier scheduling, the method comprising:
receiving a configuration for a first group of cells to be scheduled;
receiving on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

38. The method of claim 37, further comprising:
receiving a configuration for a plurality of groups of cells and wherein the downlink control information comprises an indication to one of the configured groups of cells, optionally, wherein the configuration corresponds to a table and the indication in the downlink control information corresponds to a row of the table.

39. The method of claim 37, wherein the configuration comprises a radio resource control, RRC, message to provide an RRC scheduling set configuration comprising parameters corresponding to the entries of a table and/or wherein the indicated two or more cells are a subset of the configured first group of cells.

40. The method of claim 37, wherein the use of a bitfield in the downlink control information is determined according to:
when an RRC scheduling set configuration is present, the bitfield is used in conjunction with the RRC configuration to determine the two or more cells from the first group of cells; and,
when no RRC scheduling set configuration is present the bitfield is used as a bitmap to determine the two or more cells from the first group of cells.

41. The method of claim 40, wherein the RRC scheduling set configuration is only provided when the number of cells to be scheduled exceeds a fixed length of the bitfield of the downlink control information.

42. The method of claim 40, wherein when the bitfield is used as a bitmap, each bit position in the bitmap corresponds to one serving cell of the two or more cells and, optionally, wherein the least significant bit to the most significant bit are mapped to cells from the smallest to largest cellid.

43. The method of claim 37, wherein the downlink control information comprises a carrier field length of 3 bits.

44. The method of claim 37, further comprising:
receiving a configuration for a second group of cells to be scheduled, wherein the second group of cells is different from the first group and comprises different cells from the first group;
receiving on the scheduling cell the downlink control information indicating two or more cells to be scheduled from one of the first group of cells and the second group of cells, optionally, wherein the downlink control information comprises a carrier selection field for indicating one of the first group of cells and the second group of cells and a bitmap wherein one bit corresponds to a cell of the two or more cells to be scheduled.

45. The method of claim 37, wherein the downlink control information for the second group of cells has a second format, different from the first, optionally, the method further comprising:
detecting one of the first format and the second format in the same search space of the scheduling cell.

46. The method of claim 45, wherein the second format comprises a first field for indicating a set index, wherein the set index indicates an index associated with the second group of configured cells and, optionally, wherein the second format further comprises a second field for indicating the set of scheduled cells from the set of configured serving cells determined from the first field.

47. The method of claim 37, wherein the first field indicating a set index is included in the downlink control information format on a scheduling cell only when the number of groups of configured cells that can be scheduled is greater than one and/or wherein the first field indicating a set index is included in a format scheduling single cell when the downlink control information format is monitored on a scheduling cell that is also configured for transmission of a downlink control information format that schedules PDSCH/PUSCH resource assignments/grants on multiple cells.

48. The method of claim 37, further comprising a cyclic redundancy check, CRC, sequence of the first format is scrambled with a first radio network temporary identifier, RNTI, and the CRC sequence of the second format is scrambled with a second RNTI.

49. The method of claim 48, wherein the first and second RNTI are configured by higher layers, and/or the first and second RNTI are distinct from each other and/or at least one of the first DCI format and the second DCI format have distinct DCI payload sizes.

50. The method of claim 37, wherein a size of at least one of the first format and the second format are indicated by higher layers and, optionally, wherein the size is indicated such that it is distinct between the formats to avoid having an explicit field.

51. The method of claim 37 wherein when a size of at least one of the first format payload and the second format payload size are equal, a set index field is included in the first and second DCI formats.

52. The method of claim 37, wherein the search space for monitoring the downlink control information is based on at least the set index associated with the first set of cells or the second set of cells and/or wherein the search space is based on the carrier selector field associated with the set.

53. The method of claim 45, wherein the downlink control information for scheduling the second group of cells is transmitted in the search space associated with the first group of cells.

54. The method of claim 37, wherein the number of sets that UE can support is indicated via a UE capability signaling message.

55. A method performed by a base station for scheduling a wireless device for carrier aggregation with cross carrier scheduling, the method comprising:
transmitting a configuration for a first group of cells to be scheduled;
transmitting on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

56. The method of claim 55, further comprising:
transmitting a configuration for a plurality of groups of cells and wherein the downlink control information comprises an indication to one of the configured groups of cells.

57. The method of claim 55, further comprising:
transmitting a configuration for a second group of cells to be scheduled, wherein the second group of cells is different from the first group and comprises different cells from the first group; and,
transmitting on the scheduling cell the downlink control information indicating two or more cells to be scheduled from one of the first group of cells and the second group of cells.

58. A wireless device comprising power supply circuitry configured to supply power to the wireless device, memory circuitry and processing circuitry, the processing circuitry configured to:
receive a configuration for a first group of cells to be scheduled; and
receive on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.

59. A base station comprising power supply circuitry configured to supply power to the base station, memory circuitry and processing circuitry, the processing circuitry configured to:
transmit a configuration for a first group of cells to be scheduled; and,
transmit on a scheduling cell a downlink control information indicating two or more cells to be scheduled from the first group of cells, wherein the downlink control information for the first group of cells has a first format and the first format comprises a first field for indicating a set index, wherein the set index indicates an index associated with the first group of configured cells and the first format further comprises a second field for indicating the set of scheduled cells from the set of configured serving cells determined from the first field.
